(19) United States
(12) Patent Application Publication
(10) Pub. No.: US 2014/0348610 A1
(43) Pub. Date: Nov. 27, 2014

(54) Dual Actuated Jackscrew Nut And/Or Bolt Head

(71) Applicant: John D. Davis, Las Vegas, NV (US)

(72) Inventor: John D. Davis, Las Vegas, NV (US)

(21) Appl. No.: 13/898,674

(22) Filed: May 21, 2013

(51) Int. Cl. F16B 39/12

(52) U.S. Cl. CPC F16B 39/12
USPC 411/214

(57) ABSTRACT

A jackscrew nut and/or bolt head assembly includes a circumferentially and radially interlocked bottom washer. Spherical faces at the washer top are thereby held in alignment with corresponding spherical jackscrew bottoms, which assures evenly distributed contact pressures during out of angle elastic jackscrew displacement during jackscrew loading. The bottom washer interlock may provide further for a transfer of a primary torque exerted onto the main body of the nut and/or bolt head via an outside spline such as well known triple square, twelve spline or the like, which may be incorporated also into the bottom washer for a concurrent application of an external torque. The assembly may be initially tightened via the primary torque whereby secondary jackscrew actuation and displacement is greatly reduced.

### FIELD OF INVENTION

The present invention relates to jackscrew nuts and bolt heads.

### BACKGROUND OF INVENTION

Jackscrew nuts and bolt heads circumvent the need for high power torque wrenches, especially with larger bolt diameters. Instead of having to tighten one nut or bolt head with high torque and big tool to bring the respective central thread connection to the required load, a number of circular arrayed jackscrews that are screwed in the nut and/or bolt head are sequentially tightened with comparatively low torques requiring only comparatively small tools. The jackscrews thereby lift off and the nut and/or bolt head from their flange position as is well known in the art.

The single actuation of nut and/or bolt head via jackscrews commonly requires extensive repetitive actuation of the individual jackscrews to induce the overall loading lift off. A substantial portion of that overall loading lift off is commonly needed in comparatively low overall nut and/or bolt load range, which would require relatively low tightening torque on the nut and/or bolt head. This in turn would substantially reduce overall jackscrew actuations. Therefore, there exists a need for a jackscrew nut and/or bolt head that provides for a dual actuation such that low load displacement may be accomplished by tightening the nut and/or bolt head directly and such that the final loading may be provided via the jackscrews. The present invention addresses this need.

During final tightening of jackscrews, contact pressures between the jackscrew bottom and the opposing washer or flange commonly cause galing between the surfaces. This substantially increases friction in the interface. In addition to load related elastic deformations and due to necessary loose thread connections, the jackscrews are forced out of their natural assembly direction.

This causes edge contact of the jackscrew bottom, which increases local peak stresses and galing even more. In the prior art it has been attempted to reduce this issue by making the jackscrew bottom slightly spherical. Nevertheless a spherical surface pressing against a planar surface causes again high peak stresses and galing. Therefore, there exists a need for a nut and/or bolt head jackscrew assembly incorporating a bottom washer with spherical faces that are held in alignment with spherical jackscrew bottoms. The present invention addresses also this need.

### SUMMARY

A jackscrew nut and/or bolt head assembly includes a circumferentially and radially interlocked bottom washer. Spherical faces at the washer top are thereby held in alignment with corresponding spherical jackscrew bottoms. The spherical-to-spherical jackscrew-washer interface assures evenly distributed contact pressures during out of angle elastic jackscrew displacement and minimizes galing.

The circumferential and radial interlocked bottom washer provides further for a transfer of a primary torque exerted onto the main body of the nut and/or bolt head via an assembly torque access, which may be a standardized outside spline such as well known triple square, twelve spline or the like. The assembly torque access may be incorporated at the top and/or circumference of the nut and/or bolt head. In case it is incorporated at the circumference, the assembly torque access may also be incorporated into the bottom washer in a fashion such that bottom washer and nut and/or bolt head may have the primary torque concurrently applied.

The washer interlock may be provided by mating splines and/or via jackscrew shafts that extend into recesses of the bottom washer. In addition and because of the spherical-to-spherical jackscrew bottom interface, the jackscrews may be in an angle with respect the central thread axis of the nut and/or bolt head such that the jackscrew heads are substantially closer to the central thread axis than the jackscrew bottoms. In that way, an overall outside diameter of the nut and/or bolt head may be kept to a minimum while providing a more centralized tool access to the individual jackscrew heads. This may be of particular advantage in tight applications of the present invention.

### BRIEF DESCRIPTION OF THE FIGURES

FIG. 1 is a front perspective view of a first embodiment of the invention in a nut configuration.

FIG. 2 is a partial cut view of FIG. 1.

FIG. 3 is a bottom perspective view of a partial assembly of FIG. 1.

FIG. 4 is a front perspective view of a second embodiment of the invention in a nut configuration

FIG. 5 is a front perspective partial cut view of a third embodiment of the invention in a bolt head configuration.

### DETAILED DESCRIPTION

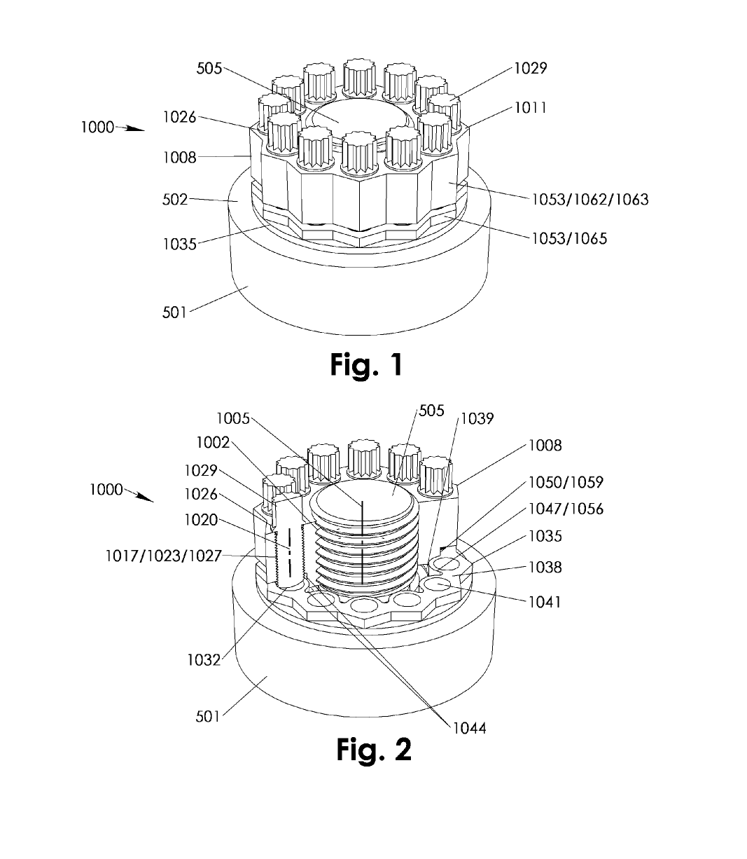

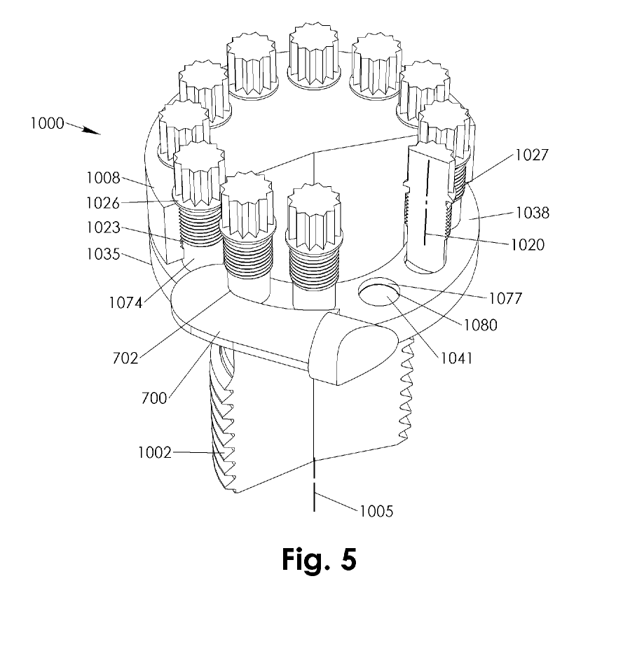

According to a first embodiment of the invention and referring to FIGS. 1-3 a jackscrew tightening assembly 1000 may feature a central thread 1002 with a thread axis 1005. In case of the jackscrew tightening assembly 1000 being a nut, the central thread 1002 may be an internal thread. In case of the jackscrew tightening assembly 1000 being a bolt head, the central thread 1002 may be an external thread as shown in FIG. 5. Parts of the jackscrew tightening assembly 1000 are a main body 1008, jackscrews 1026, a bottom washer 1035 and a washer interlock 1044. The main body 1008 is extending radial outward with respect to the central thread 1002 as is well known for jackscrew nuts and/or bolts. The main body 1008 has a main top 1011, a main bottom 1014 that is opposite the main top 1011 in axial direction with respect to the central thread axis 1005, through holes 1017 with a through hole axis 1020 that is in an offset to the central thread axis 1005, and a secondary thread 1023 at least along a portion of the through hole 1017. The jackscrews 1026 are extending through respective through holes 1017, and engaging via their jackscrew threads 1027 with the respective secondary threads 1023. The jackscrews 1026 have jackscrew heads 1029 facing away from the main bottom 1014 and spherical bottoms 1032 facing away from the main top 1011. The jackscrews 1026 are preferably arrayed in a number around the central thread 1002 such that upon even tightening of all jackscrews 1026 the axial sum of all their individually exerted axial loads is transferred onto the central thread 1002 in a balanced fashion via the main body 1008 as may be well appreciated by anyone skilled in the art.

The bottom washer 1035 is adjacent the main bottom 1014 and surrounding the central thread 1002. The bottom washer 1035 has a washer top 1038 that is facing the main bottom 1014 and a number of spherical faces 1041 that are formed into the washer top 1038. The spherical faces 1041 are matching their respective spherical bottoms 1032 and are in substantial axial alignment with them and rotationally symmetric with respect to the central thread axis 1005. The bottom washer 1035 is at least circumferentially but preferably also radial held with the main body 1008 via a washer interlock 1044 that includes a first interlock feature 1047 provided by the bottom washer 1035 and a second interlock feature 1050 that is at least circumferentially but preferably also radial mating the first interlock feature 1047 and that is part of the main body 1008 such that the spherical faces 1041 are held in alignment with respective spherical bottoms 1032. The first interlock feature 1047 may be an internal spline that is axially extending through a central through hole 1039 of the bottom washer 1035. The second interlock feature 1050 may be an external spline axially extending from the main bottom 1014. According to FIGS. 1, 2, the second interlock feature 1050 may be a body contour 1062 axially extending from the main bottom 1014 towards the main top 1011 and the first interlock feature may be one or more protrusions axially extending above the washer top 1038.

Further part of the jackscrew tightening assembly 1000 may be an assembly torque access 1053 via which a primary torque may be externally applied to the jackscrew tightening assembly 1000. The assembly torque access may be part of at least one of the main body 1008 and the bottom washer 1035 such that the primary torque that is applied to at least one of the main body 1008 and the bottom washer 1035 is also applied via the washer interlock 1044 to one other of the main body 1008 and the bottom washer 1035 while the spherical bottoms 1032 remain in substantial axial alignment with their respective spherical faces 1041. The assembly torque access 1053 may be a body outside contour 1063 that at least in part corresponds to a well known twelve spline, triple square standard or the like. The body outside contour may also serve as the second interlock feature 1050. Part of the assembly torque access 1053 may also be a bottom washer contour 1065 that is axially substantially collinear with the body outside contour 1063 such that the primary torque may be concurrently applied to both the main body 1008 and the bottom washer 1035 with the same tool as may well appreciated by anyone skilled in the art.

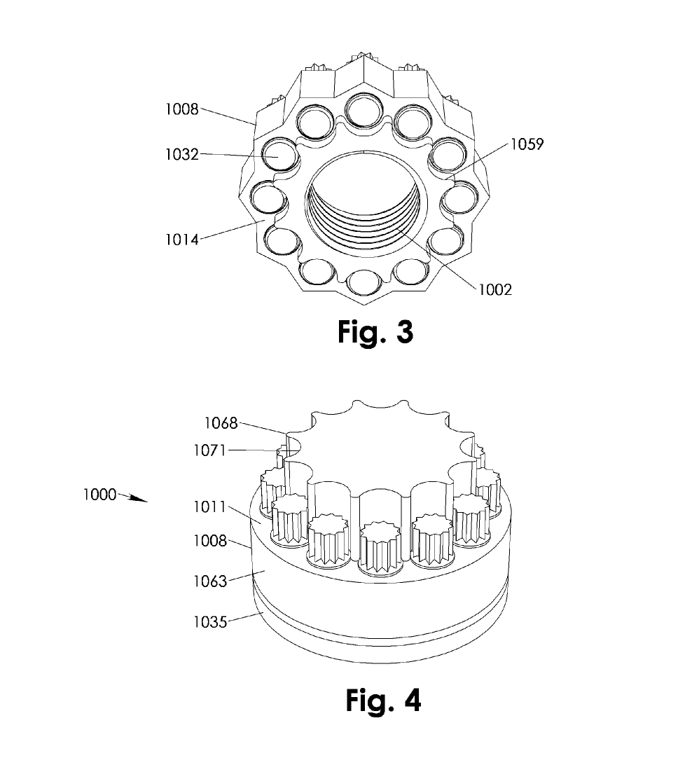

According to FIG. 3, the assembly torque access 1053 may be a body top spline 1068 protruding from the main top 1011. The body top spline 1068 may have jackscrew access recesses 1071 that are radial recessed into it such that the jackscrew heads 1029 are accessible while the body top spline 1068 radial extends in between the jackscrew heads 1029.

Referring to FIG. 5, the main body 1008 and the bottom washer 1035 may be circumferentially and radial held together via interlock shafts 1074 of the jackscrews 1026 engaging with receptacles 1077 formed into the bottom washer 1035. Receptacle disks 1080 featuring the spherical faces 1041 may be placed inside and preferably at the bottom of the receptacles 1077. Their small size provides for a cost effective fabrication of them with superior hardness of at least their spherical faces 1041, which may further reduce risk of galing in the interface as may be well appreciated by anyone skilled in the art. At the same time, the bottom washer 1035 may be fabricated from a less hard and brittle material making it less susceptible to cracking due to out of balance peak loading from the jackscrews 1026 as may also be well appreciated by anyone skilled in the art.

The interlock shafts 1074 may be accessed via the axial gap between the main body 1008 and the bottom washer 1035 by a hook tool 700 having a hook 702 corresponding to the diameter of the interlock shafts 1074. By use of the hook tool, the primary torque may be applied for initially tightening the main body 1008. The hook tool 700 provides torque transfer with only partial circumferential access to the main body 1008, which may be advantages in tight locations.

At least one of the jackscrews 1026, the bottom washer 1035, the main body and the receptacle disks 1080 may be permanently magnetic to assist in keeping the jackscrew tightening assembly 1000 together during its installation and handling. The through hole axes 1020 may be in an angle to the central thread axis 1005 such that the jackscrew heads 1029 are closer to the central thread axis 1005 than the spherical bottoms 1032. This may advantageously provide for a more centralized access to the jackscrew heads 1029 with a tightening tool, while at the same time keeping the most outward diameter of the main body 1008 to a minimum.

In case the bottom washer 1035 is configured as a well known lock washer with one directional serrations on its bottom or other features preventing the bottom washer 1035 from being rotated in loosening direction of the main body 1008, the jackscrews 1026 may be loosened to the extent that the jackscrew shafts 1074 disengage from the receptacles 1077 and the main body 1035 rests directly on the washer top 1038 prior to loosening the main body 1008. That way, the locking bottom washer 1035 may remain stationary while the main body 1035 slides on the washer top 1038. To provide still a gap for hook tool 700 access, the main body 1008 may have a central circular rim extending downward from the main bottom 1014.

Accordingly, the scope of the Figures and the Specification above is set forth by the following claims and their legal equivalent:

What is claimed is:

1. A jackscrew tightening assembly comprising:
a. a central thread with a central thread axis;
b. a main body radially outward extending with respect to said central thread, said main body comprising:
i. a main top;
ii. a main bottom that is opposite said main top in axial direction with respect to said central thread axis;
iii. a through hole with a through hole axis being in an offset to said central thread axis;
iv. a secondary thread at least along a portion of said through hole;
c. a jackscrew that is extending through said through hole and that is engaging with said secondary thread, said jackscrew comprising:
i. a jackscrew head that is facing away from said main bottom;
ii. a spherical bottom that is facing away from said main top
d. a bottom washer that is adjacent to said main bottom and that is surrounding said central thread, said bottom washer comprising:
i. a washer top that is facing said main bottom;
ii. a spherical face that is formed into said washer top and that is in substantial axial alignment with said spherical bottom with respect to said central thread axis and that is matching said spherical bottom;
e. a washer interlock that is circumferentially and radially holding said bottom washer with said main body, said washer interlock comprising:
i. a first interlock feature being part of said bottom washer; and
ii. a second interlock feature that is circumferentially and radially mating said first interlock and that is part of said main body such that said spherical face is held in alignment with said spherical bottom.

2. The jackscrew tightening assembly of claim 1 being a nut and said central thread being an internal thread.

3. The jackscrew tightening assembly of claim 1 being a bolt and said central thread being an external thread.

4. The jackscrew tightening assembly of claim 1, wherein:
a. said first interlock feature is an internal spline that is axially extending along a central through hole of said bottom washer; and
b. said second interlock feature is an external spline axially extending from said main bottom.

5. The jackscrew tightening assembly of claim 1, wherein:
a. said second interlock feature is a body contour axially extending from said main bottom towards said main top; and
b. said first interlock feature is a protrusion that is axially extending above said washer top.

6. The jackscrew tightening assembly of claim 5, wherein said body contour is a body outside contour.

7. The jackscrew tightening assembly of claim 1, wherein at least one of said main body, said bottom washer, and said jackscrew disk is magnetic.

8. The jackscrew tightening assembly of claim 1, wherein said thread hole axis is in an angle to said central thread axis such that said jackscrew head is closer to said central thread axis than said spherical bottom.

9. The jackscrew tightening assembly of claim 1, further comprising an assembly torque access that is part of at least one of said main body and said bottom washer such that an externally applied primary torque that is applied to said at least one of said main body and said bottom washer is also applied via said washer interlock to one other of said main body and said bottom washer while said spherical bottom remains in substantial axial alignment with said spherical face.

10. The jackscrew tightening assembly of claim 9, wherein said assembly torque access comprises a body outside contour.

11. The jackscrew tightening assembly of claim 10, wherein said assembly torque access comprises a bottom washer contour that is axially substantially collinear with said body outside contour.

12. The jackscrew tightening assembly of claim 9, wherein said assembly torque access comprises a body top spline protruding from said main top.

13. The jackscrew tightening assembly of claim 12, wherein said body top spline comprises a jackscrew access recess that is radially recessed in said body top spline.

14. A jackscrew tightening assembly comprising:
a. a central thread with a central thread axis;
b. a main body radially outward extending with respect to said central main thread, said main body comprising:
i. a main top;
ii. a main bottom that is opposite said top side in axial direction with respect to said central thread axis;
iii. a through hole with a through hole axis being in an offset to said central thread axis;
iv. a secondary thread at least along a portion of said through hole;
c. a jackscrew that is extending through said through hole and that is engaging with said secondary thread, said jackscrew comprising:
i. a jackscrew head that is facing away from said main bottom;
ii. a spherical bottom that is facing away from said main top;
iii. an interlock shaft adjacent said spherical bottom;
d. a bottom washer that is adjacent to said main bottom and that is surrounding said central thread, said bottom washer comprising:
i. a receptacle that is formed into said bottom washer and that is circumferentially and radially holding said bottom washer with said jackscrew via said interlock shaft; and
ii. a spherical face that is in substantial axial alignment with said spherical bottom with respect to said central thread axis.

15. The jackscrew tightening assembly of claim 14 being a nut and said central thread being an internal thread.

16. The jackscrew tightening assembly of claim 14 being a bolt and said central thread being an external thread.

17. The jackscrew tightening assembly of claim 14, further comprising a assembly torque access that is part of at least one of said main body, said jackscrew and said bottom washer such that an externally applied primary torque that is applied to said at least one of said main body, said jackscrew and said bottom washer is also applied via said interlock shaft and said receptacle to one other of said main body and said bottom washer while said spherical bottom remains in substantial axial alignment with said spherical bottom.

18. The jackscrew tightening assembly of claim 17, wherein said assembly torque access comprises a body outside contour.

19. The dual actuated jackscrew tightening assembly of claim 18, wherein said assembly torque access comprises a bottom washer contour that is axially substantially collinear with said body outside contour.

20. The dual actuated jackscrew tightening assembly of claim 17, wherein said assembly torque access comprises a body top spline protruding from said main top.

21. The dual actuated jackscrew tightening assembly of claim 20, wherein body top spline comprises a jackscrew access recess that is radially formed in said body top spline.

22. The dual actuated jackscrew tightening assembly of claim 17, wherein:
a. a portion of said interlock shaft is peripherally accessible in between said main body and said bottom washer; and
b. wherein said assembly torque access includes said interlock shaft portion.

23. The jackscrew tightening assembly of claim 14, further comprising a receptacle disk inside said receptacle, said receptacle disk comprising said spherical face.

24. The jackscrew tightening assembly of claim 23, wherein at least one of said main body, said bottom washer, said jackscrew and said receptacle disk is magnetic.

25. The jackscrew tightening assembly of claim 14, wherein said through hole axis is in an angle to said central thread axis such that said jackscrew head is closer to said central thread axis than said spherical bottom.
